(19) United States
(12) Patent Application Publication
(10) Pub. No.: US 2019/0168226 A1
(43) Pub. Date: Jun. 6, 2019

(54) GRAIN POWDER AND METHOD OF PRODUCING THEREOF

(71) Applicant: Mcnulty Joint Research Corporation Association, Cheonan-si (KR)

(72) Inventors: Eun Jung LEE, Seoul (KR); Il Nam Lee, Gimpo-si (KR); Ho Jun Jeong, Seoul (KR)

(21) Appl. No.: 16/178,102

(22) Filed: Nov. 1, 2018

(30) Foreign Application Priority Data
Nov. 2, 2017 (KR) 10-2017-0145316
Dec. 18, 2017 (KR) 10-2017-0174006

(51) Int. Cl. B02C 11/08; A23B 9/10; A23L 7/10

(52) U.S. Cl. CPC B02C 11/08; A23V 2002/00; A23L 7/198; A23B 9/10

(57) ABSTRACT

The present disclosure relates to a method of producing a grain powder including: (a) immersing a grain raw material into water; (b) freezing the immersed grain raw material at −196° C. to −50° C.; (c) grinding the frozen grain raw material to obtain a ground product, wherein the ground product has an average particle size smaller than a cell size of the grain raw material, and (d) freeze-drying the ground product at −80° C. to −20° C. to obtain the grain powder.

### CROSS-REFERENCE TO RELATED APPLICATIONS

This application claims priority to and the benefit of Korean Patent Application No. 10-2017-0145316 filed in the Korean Intellectual Property Office on Nov. 2, 2017 and 10-2017-0174006 filed in the Korean Intellectual Property Office on Dec. 18, 2017 the entire contents of which are incorporated herein by reference.

### TECHNICAL FIELD

The present invention relates to a grain powder and a method for producing thereof using cryogenic micro grinding technology. This method increases a content of nutritious ingredients of grains and improving in vivo absorption rate and digestion rate by grinding grains using a cryogenic micro grinding technology (CMGT).

### BACKGROUND ART

Recently, various types of health functional foods, supplements, raw grains and vegetables, which includes nutritious ingredients, have been widely consumed.

In order to intake carbohydrate-containing food, whole grains are usually consumed as they are, or simply powdered and used. Intaking grains, which are being immersed, is limited to the use when grains are consumed in the form of a beverage. Carbohydrate-containing food in a form, which can be conveniently consumed without being restricted to space and time in everyday life and improves storability, has been usefully utilized.

Brown rice is rice that has only its husk removed. Brown rice has most of the nutrients in its embryo and bran, and contains more nutritious ingredients, such as dietary fiber, amino acid, phytic acid, and vitamins B and E, than white rice. Further, as brown rice, various varieties of colored rice from reddish brown to dark purple have been cultivated, and reddish brown-type brown rice contains a tannin-based dye and dark purple-type brown rice contains an anthocyanin-based dye. Moreover, brown rice exhibiting green color due to delayed loss of chlorophyll in the pericarp during the ripening period, that is, green rice is also produced. It has been reported that tannin-based dyes included in these varieties of colored rice are effective for removing toxic heavy metals and suppressing production of mutagens, and the like, and anthocyanin-based dyes retain effects such as antioxidant and anticancer functions. Further, chlorophyll has effects such as hematopoiesis, anticancer and anti-inflammation. Consumers' attention on brown rice has increased due to various physiological activities which brown rice has, but the consumption of brown rice has not been significantly increased due to the rough texture of brown rice. However, when brown rice is germinated, starch, polysaccharides, proteins, and the like are degraded, and as a result, preference is enhanced by increasing oligosaccharide and amino acid. In addition, it has been reported that cell wall degrading enzymes act, and as a result, a portion of hulls of brown rice are hydrolyzed and the structure is softened, thereby improving the rough texture of brown rice. It has been reported that the contents of various nutrients, that is, various vitamins, minerals, enzymes, arabinoxylans, amino acids, α-aminobutyric acid (GABA), and the like are increased after germination of brown rice.

Bean is an excellent vegetable protein source, has become an important protein source in the form of food such as tofu, fermented soybean paste, red pepper paste, bean paste prepared with ground fermented soybean, soybean milk, and soybean oil, and has also widely been used as an industrial raw material such as medicine, cosmetics, and soap in addition to the protein source. Recently, as studies on not only nutritional aspects of bean, but also physiologically active materials such as hemagglutinin, saponin, and isoflavones have been actively conducted, bean has come into the limelight as a functional food due to attention to health functional effects such as anticancer, anti-atherosclerotic, antioxidant, hypoglycemic, and antibacterial effects. Since bean contains 9.2% of moisture, 41.3% of protein, 17.6% of crude fat, 22.6% of glucide, 3.5% of crude fiber, and 5.8% of ash, and particularly, essential fatty acids and essential amino acids are evenly contained therein, bean has been used as a processed food such as fermented soybean paste, soy sauce, tofu, and bean sprout for a long period of time. However, as anticancer effects, cholesterol reducing effects, immunity reinforcement, adult disease preventing effects, and the like of bean have been recently revealed, attempts to use bean in the non-processed and uncooked form have been made, but bean contains a trypsin inhibitor, hematoglutin, saponin, tannin, and the like as toxic materials and has such a hard structure that bean in a non-processed state has disadvantages in that the digestion absorption rate is low and the inherent odor from the bean reduces the appetite.

Thus, the present inventors powdered grains (e.g., germinated brown rice, black bean, and a germinated grain and vegetable mixture), which contain a large amount of carbohydrate, by a cryogenic micro grinding technology, thereby producing a portable carbohydrate-containing food powder which is highly portable and easily digestible.

### SUMMARY OF THE INVENTION

According to one aspect of the present invention, a method of producing a grain powder is provided, which comprises (a) immersing a grain raw material into water; (b) freezing the immersed grain raw material at −196° C. to −50° C.; (c) grinding the frozen grain raw material to obtain a ground product, wherein the ground product has an average particle size smaller than a cell size of the grain raw material, and (d) freeze-drying the ground product at −80° C. to −20° C. to obtain the grain powder. The grinding step (c) may be performed at −80° C. to −50° C. The temperature of the grain product may be maintained between −80° C. to −20° C. during the grinding step (c).

The grain raw material may be germinated brown rice, black bean, and/or a germinated grain and vegetable mixture. The average particle size of the ground product may be 5 to 30 μm. The immersing step (a) may be performed at 2° C. to 20° C. for 60 to 180 minutes. The freezing step (b) may be performed by using a liquid nitrogen.

The grain powder may have a higher nutrient retention rate and in vivo digestion rate than the grain raw material. When the grain raw material is black bean or a germinated grain and vegetable mixture, the in vivo digestion rate of the grain powder may be 50 to 60% higher than an in vivo digestion rate of the grain raw material. Also, when the grain raw material is germinated brown rice, the in vivo digestion rate of the grain powder may be 3,500 to 4,500% higher than an in vivo digestion rate of the grain raw material.

In accordance with another aspect of the present invention, a grain powder is provided, which comprises: a freeze-dried and ground grain raw material, wherein an average particle size of the grain powder is smaller than a cell size of the grain raw material, and wherein the grain powder has a higher nutrient retention rate than the grain raw material, and the grain powder has a higher in vivo digestion rate than the grain raw material.

In yet another aspect of the present invention, a food product comprising the above grain powder is provided. The food product may further comprise one or more of a carrier, a diluent, an excipient, and an additive. The food product may be in a form of a powder, a granule, a tablet, a capsule, a syrup or a bar.

These and other aspects will be appreciated by one of ordinary skill in the art upon reading and understanding the following specification.

### DETAILED DESCRIPTION

The present disclosure is related to a cryogenic micro grinding technology (CMGT), which may include a technology of directly grinding raw materials (e.g., grains) into a fine powder in a state where the raw materials are frozen hard at a cryogenic temperature of −196° C. to −50° C., more preferably, −80° C. to −50° C.

The grain powder according to the present disclosure can maintain a content of nutrients of the raw material and increase in vivo digestion rate and absorption rate.

A general freeze drying uses a vacuum drying method after freezing a raw material at −20° C. to −40° C., whereas in the present disclosure, the raw material in a frozen particle state (e.g., −20° C. to −80° C.) can be directly introduced into a freeze drying process from the beginning, thereby minimizing freeze impact imposed on the raw material.

When a plant containing a large amount of carbohydrate is micro ground at a cryogenic temperature according to the present disclosure, it exhibits effects in that by minimizing destruction of nutrients, a content of nutrients of the raw material are maximally maintained and a bio-absorption rate is improved. When an immersed grain raw material is frozen and ground at a cryogenic temperature, the cell wall of the grain raw material, which is saturated with water and expanded by swelling the structure of carbohydrate, can be ground to have a microstructure having a size of 5 μm to 30 μm, which may be smaller than the cell size of the grain raw material. Thereafter, after moisture is removed, the ground grain powders have smaller sizes than the case where the grains are ground without the immersion. When grains thus finely powdered are used, moisture can permeates more easily and thus, better conditions under which in vivo digestive enzymes act are created, thereby greatly increasing the physical availability of carbohydrate ingredients.

The immersing of the grain raw material can be performed at 2° C. to 20° C. for 60 to 180 minutes. More preferably, the immersing step can be performed at 2-4° C. for 60 to 150 minutes. When the grain raw materials are immersed higher than 20° C., propagation of microorganisms, elution of the nutrients and/or gelatination of the starch included in the gain raw material may occur. In addition, when the grain raw materials are immersed lower than 2° C., the grain raw materials are not sufficiently immersed.

The germinated grain and vegetable mixture used in one of the embodiments of the present disclosure was purchased from a specialized vendor who supplies grains and plants in Pocheon, Gyeonggi Province, which consists of 91.2% of germinated grains consisting of barley, corn, wheat, buckwheat, black rice, sorghum, glutinous millet, black bean, red bean, Job's-tears, and black sesame and 8.8% of plants consisting of carrot, cabbage, kale, mugwort, pine needle, spinach, sweet potato, potato, pumpkin, jujube, shiitake mushroom, kelp, and seaweed. However, other germinated grain and vegetable mixture can be used, and the present disclosure is not limited to the composition of the mixture.

According to another embodiments of the present disclosure, there are effects in that destruction of nutrients of grains is minimized while the grains are immersed, and then the immersed grains are subjected to a cryogenic micro grinding process, the content of nutrients of the grain raw material can be maximally maintained, and in vivo digestion rate and absorption rate are improved.

Meanwhile, it is possible to provide a health functional food including the above-described grain powder. The health functional food further includes one or more of a carrier, a diluent, an excipient, and an additive, and thus, is characterized by being formulated with one selected from the group consisting of a tablet, a pill, a pulvis, a granule, a powder, a capsule, and a liquid formulation.

Examples of a food to which the powder of the present disclosure can be added include various foods, a powder, a granule, a tablet, a capsule, a syrup, a bar form, and the like. As the additive, it is possible to use one or more ingredients selected from the group consisting of a natural carbohydrate, a flavorant, a nutrient, a vitamin, a mineral (electrolyte), a flavoring agent (a synthetic flavoring agent, a natural flavoring agent, and the like), a colorant, a filler (cheese, chocolate, and the like), pectic acid and a salt thereof, alginic acid and a salt thereof, organic acid, a protective colloid thickener, a pH adjusting agent, a stabilizer, a preservative, an antioxidant, glycerin, alcohol, a carbonating agent, and fruit pulp.

Examples of the above-described natural carbohydrate include common sugars such as monosaccharides, for example, glucose, fructose and the like; disaccharides, for example, maltose, sucrose and the like; and polysaccharides, for example, dextrin, cyclodextrin and the like, and sugar alcohols such as xylitol, sorbitol, and erythritol. As the flavorant, a natural flavorant (thaumatin, stevia extract (for example, Rebaudioside A, glycyrrhizin and the like), and a synthetic flavorant (saccharin, aspartame and the like) may be advantageously used.

The health functional food of the present disclosure may contain various nutrients, vitamins, minerals (electrolytes), flavoring agents such as synthetic flavoring agents and natural flavoring agents, colorants and fillers (cheese, chocolate, and the like), pectic acid and salts thereof, alginic acid and salts thereof, organic acids, protective colloid thickeners, pH adjusting agents, stabilizers, preservatives, glycerin, alcohols, carbonating agents used in a carbonated beverage, or the like, in addition to the additives.

Specific examples of the carrier, the excipient, the diluent, and the additive are not limited to the followings, but it is preferred that one or more selected from the group consisting of lactose, dextrose, sucrose, sorbitol, mannitol, erythritol, starch, acacia rubber, calcium phosphate, alginate, gelatin, calcium phosphate, calcium silicate, microcrystalline cellulose, polyvinylpyrrolidone, cellulose, water, sugar syrup, methyl cellulose, methyl hydroxybenzoate, propyl hydroxybenzoate, talc, magnesium stearate, and mineral oil are used.

When the health functional food according to the present disclosure is formulated, the health functional food is prepared by using a diluent or excipient, such as a filler, an extender, a binder, a wetting agent, a disintegrant, and a surfactant, commonly used. The content of the powder according to the present disclosure as an effective ingredient in the above-described formulation may be appropriately adjusted by the use form and purpose, the condition of a patient, the type and severity of symptom, and the like, and may be 0.001 to 99.9 wt %, preferably 0.01 to 50 wt % based on the weight of a solid content, but is not limited thereto.

The powder according to the present disclosure may be commercialized as a patient food, a senior food, an infant food, a nutrition food, a space food, a diet food, a protein supplemented food, and an antioxidant supplemented food. According to the purpose which needs supply of carbohydrate, 10 to 80% of the powder according to the present disclosure is contained, and may be utilized as a powder, a granulated granule product, a pill, a bar form, a product in the form of liquid food, and a product in the form of a hard capsule, a soft capsule, a tablet, and the like. For example, the patient food may be used in a product for a patient during the recovery period, who is in need of carbohydrate supply, and may be used as a powder or granulated granule product, or a liquid food or tube food product, which contains 20 to 70% of the powder according to the present disclosure. The senior food and the infant food may be used in a product for a senior or an infant, who is in need of carbohydrate supply, and may be used as a powder or granulated granule product, a pill, a bar form, or a product in the form of liquid food, which contains 20 to 70% of the powder according to the present disclosure. The nutrition food may be used in a product for a minor or an adult, who is in need of carbohydrate supply, and may be used as a powder or granulated granule product, a bar form, or a product in the form of liquid food, which contains 10 to 60% of the powder according to the present disclosure.

### BRIEF DESCRIPTION OF THE DRAWINGS

FIG. 1 illustrates a process diagram of immersing grains, and then powdering the grains by a CMGT method.

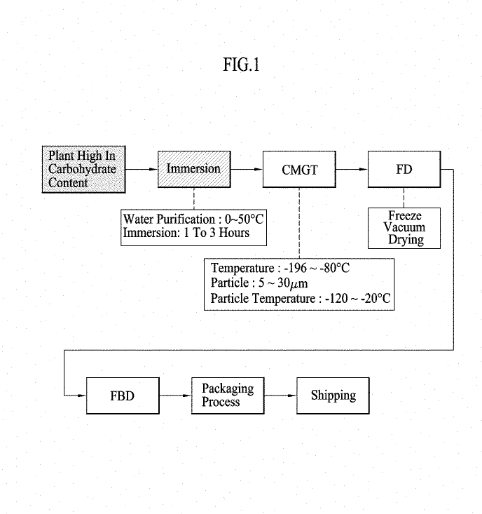

FIG. 2 illustrates the absorption amount of moisture of a germinated grain and vegetable mixture over the immersion time and the temperature.

FIG. 3 illustrates the absorption amount of moisture of black beans over the immersion time and the temperature.

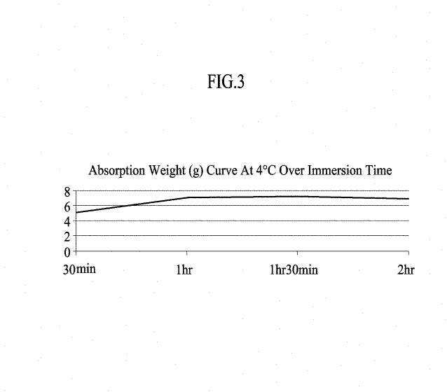

FIG. 4 illustrates the absorption amount of moisture of germinated brown rice over the immersion time and the temperature.

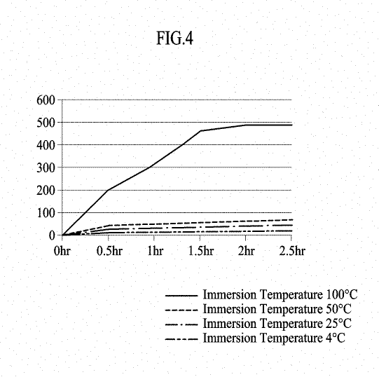

FIG. 5 is a graph comparing rates of change of nutritious ingredients between powder obtained by subjecting germinated brown rice to general grinding and powder obtained by subjecting germinated brown rice to cryogenic micro grinding.

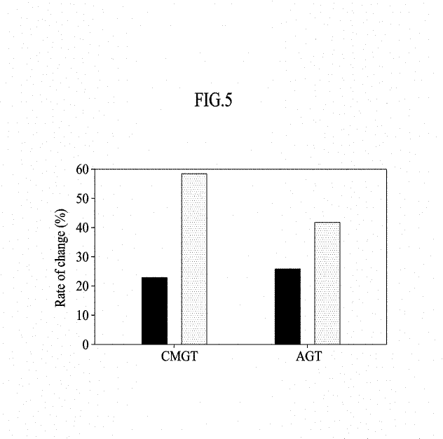

FIG. 6 illustrates particle size analysis results of powder obtained by subjecting a germinated grain and vegetable mixture to general grinding.

FIG. 7 illustrates particle size analysis results of powder obtained by subjecting a germinated grain and vegetable mixture to cryogenic micro grinding.

FIG. 8 illustrates particle size analysis results of powder obtained by subjecting black beans to general grinding.

FIG. 9 illustrates particle size analysis results of powder obtained by subjecting black beans to cryogenic micro grinding.

FIG. 10 illustrates particle size analysis results of powder obtained by subjecting germinated brown rice to general grinding.

FIG. 11 illustrates particle size analysis results of powder obtained by subjecting germinated brown rice to cryogenic micro grinding.

FIG. 12 is an SEM cross-sectional image of powder obtained by subjecting germinated brown rice to general grinding and cryogenic micro grinding.

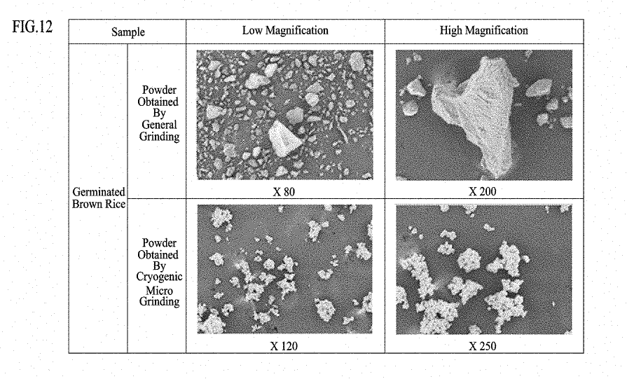

FIG. 13 is an SEM cross-sectional image of powder obtained by subjecting black beans to general grinding and cryogenic micro grinding.

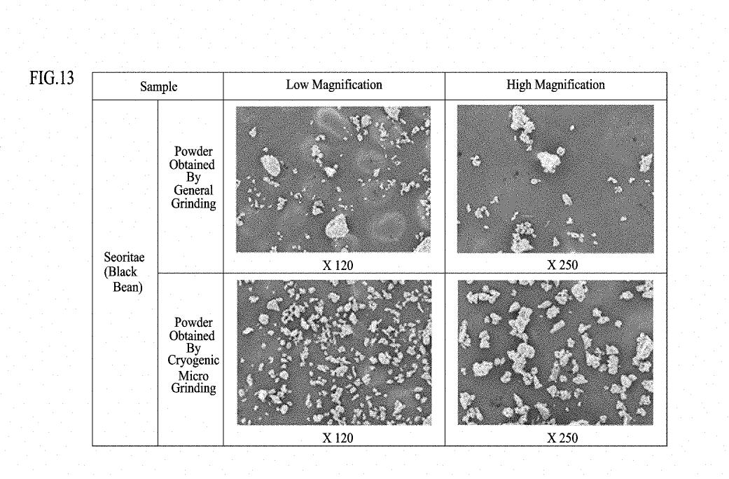

FIG. 14 is an SEM cross-sectional image of powder obtained by subjecting a germinated grain and vegetable mixture to general grinding and cryogenic micro grinding.

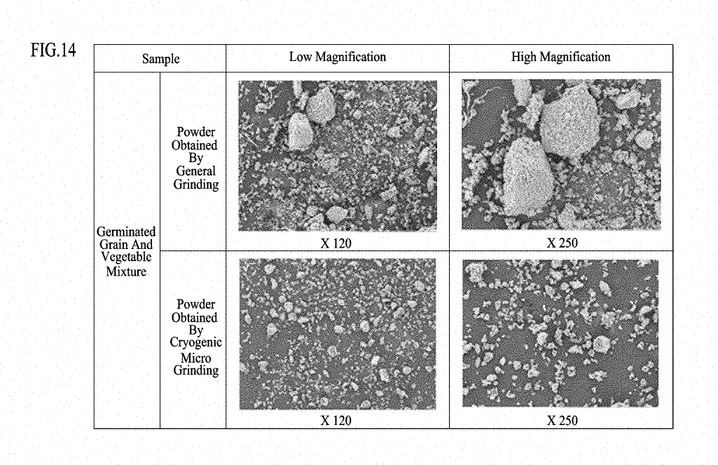

Hereinafter, the present disclosure will be described in more detail through Examples. These Examples are provided only for more specifically describing the present disclosure, and it will be obvious to a person with ordinary skill in the art to which the present disclosure pertains that the scope of the present invention is not limited by these Examples according to the gist of the present disclosure.

### EXAMPLE 1

Immersion and Grinding of Grains

1-1. Germinated Brown Rice

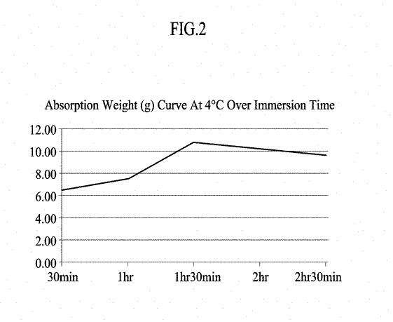

In order to confirm an immersion condition suitable for a cryogenic micro grinding technology, by varying the immersion time and the immersion temperature, germinated brown rice was immersed and the absorption amount of moisture was measured. Water in an amount as much as five times was added to 100 g of germinated brown rice, and the germinated brown rice was immersed by varying the time based on a unit of 30 minutes from 30 minutes to 2 hours and 30 minutes while maintaining the temperature at 4° C., 25° C., 50° C., and 100° C., respectively in a water bath. After the immersion, moisture of germinated brown rice was removed with a filter net, moisture on the surface thereof was removed by pressing down on germinated brown rice with a filter paper, and then the weight was measured to measure the variation in absorption amount of moisture for 100 g of germinated brown rice over temperature. At 50° C. and 100° C., water was prevented from being evaporated by cooling the germinated brown rice three times with iced water in order to prevent evaporation by heat, and then the weight was measured. Consequently, as a result of immersion at 100° C. for 30 minutes, germinated brown rice became soft due to the gelatinization action and became viscous, so that the germinated brown rice was not appropriate for use in the micro grinding technology. When the germinated brown rice immersed at a temperature of 25° C. or more was allowed to absorb moisture for 3 hours or more, a problem in that the flavor of germinated brown rice deteriorated due to the change such as propagation of microorganisms and gelatinization occurred. Meanwhile, when the germinated brown rice was immersed at a temperature of 50° C. or more, the rate at which moisture permeated was rapid in consideration of the low temperature, but starch became soft, and as a result, a problem occurred in that the workability deteriorated. From this result, it was confirmed that that germinated brown rice immersed at 4° C. for 2 hours became suitable for being applied to the cryogenic micro grinding technology (FIG. 2).

TABLE 1

| Classification | | Absorbed weight (g) at each immersion temperature | | | |
|---|---|---|---|---|---|
| Immersion time | | 4° C. | 25° C. | 50° C. | 100° C. |
| 0 | hour | 0 | 0 | 0 | 0 |
| 0.5 | hour | 11.52 | 13.84 | 18.2 | 150 |
| 1 | hour | 14.9 | 18.74 | 20.38 | 260 |
| 1.5 | hours | 16.98 | 20.38 | 23.02 | 398 |
| 2 | hours | 17.9 | 20.4 | 23.9 | 423.2 |
| 2.5 | hours | 19.62 | 23.16 | 24.74 | 424.8 |

1-2 Germinated Grain and Vegetable Mixture

Similarly in Example 1-1, water in an amount as much as five times was added to 20 g of a germinated grain and vegetable mixture, and the germinated grain and vegetable mixture was immersed by varying the time based on a unit of 30 minutes from 30 minutes to 2 hours and 30 minutes while maintaining the temperature at 4° C., 25° C., 50° C., and 100° C. in a water bath. When the immersion time was reached, water was removed, moisture was removed with a paper towel, and then the weight was measured. At 50° C. and 100° C., water was prevented from being evaporated by cooling the germinated grain and vegetable mixture three times with iced water in order to prevent evaporation by heat, and then the weight was measured.

TABLE 2

| | | | Before | After | Increased | |
|---|---|---|---|---|---|---|
| Immersion | Immersion | | immersion | immersion | weight | Increase |
| temperature | time | | (g) | (g) | (g) | % |
| 4° C. | 0.5 | hour | 20.30 | 26.89 | 6.59 | 32.43 |
| | 1 | hour | 20.74 | 28.35 | 7.61 | 36.69 |
| | 1.5 | hours | 20.83 | 31.57 | 10.74 | 51.55 |
| | 2 | hours | 20.95 | 31.03 | 10.08 | 48.11 |
| | 2.5 | hours | 20.62 | 30.25 | 9.62 | 46.67 |
| 25° C. | 0.5 | hour | 20.79 | 30.47 | 9.68 | 46.56 |
| | 1 | hour | 20.14 | 31.63 | 11.49 | 57.04 |
| | 1.5 | hours | 20.12 | 33.49 | 13.37 | 66.47 |
| | 2 | hours | 20.25 | 33.45 | 13.20 | 65.18 |
| | 2.5 | hours | 20.46 | 35.47 | 15.01 | 73.39 |
| 50° C. | 1 | hour | 20.02 | 38.81 | 18.79 | 93.88 |
| | 2 | hours | 20.10 | 41.28 | 21.18 | 105.37 |
| | 3 | hours | 20.16 | 42.84 | 22.68 | 112.48 |
| | 4 | hours | 20.20 | 40.37 | 20.16 | 99.81 |
| | 5 | hours | 20.11 | 40.42 | 20.31 | 101.02 |
| 100° C. | 10 | minutes | 20.19 | 40.19 | 20.00 | 99.07 |
| | 20 | minutes | 20.38 | 42.67 | 22.29 | 109.35 |
| | 30 | minutes | 20.38 | 45.76 | 25.37 | 124.47 |
| | 40 | minutes | 20.76 | 47.39 | 26.63 | 128.25 |
| | 50 | minutes | 20.23 | 51.41 | 31.18 | 154.18 |

As a result, the absorption amount was reduced under a condition after 1 hour and 30 minutes, and at 25° C. or more, the microorganisms could be propagated and it was confirmed by the unaided eye that the dyes were gradually eluted, so that it could not be expected to preserve nutritious ingredients. Even at 50° C. and 100° C., it was confirmed by the unaided eye that the dyes were eluted, so that it could not be expected to preserve nutritious ingredients. From this result, it was confirmed that the germinated grain and vegetable mixture immersed at 4° C. for 1 hour and 30 minutes became suitable for being applied to the cryogenic micro grinding technology.

1-3 Black Bean

TABLE 3

| | | | Before | After | Increased | |
|---|---|---|---|---|---|---|
| Immersion | Immersion | | immersion | immersion | weight | Increase |
| temperature | time | | (g) | (g) | (g) | % |
| 4° C. | 0.5 | hour | 20.78 | 25.87 | 5.09 | 24.51 |
| | 1 | hour | 20.68 | 27.65 | 6.98 | 33.74 |
| | 1.5 | hours | 20.94 | 28.21 | 7.27 | 34.71 |
| | 2 | hours | 20.72 | 27.61 | 6.89 | 33.25 |
| | 2.5 | hours | 20.69 | 29.16 | 8.47 | 40.95 |
| 25° C. | 0.5 | hour | 20.20 | 29.02 | 8.82 | 43.67 |
| | 1 | hour | 20.88 | 30.47 | 9.59 | 45.93 |
| | 1.5 | hours | 20.83 | 31.88 | 11.05 | 53.05 |
| | 2 | hours | 20.87 | 34.20 | 13.32 | 63.83 |
| | 2.5 | hours | 20.72 | 34.89 | 14.17 | 68.39 |
| 50° C. | 1 | hour | 20.89 | 36.40 | 15.51 | 74.25 |
| | 2 | hours | 20.78 | 42.18 | 21.40 | 103.00 |
| | 3 | hours | 20.82 | 44.53 | 23.71 | 113.91 |
| | 4 | hours | 20.69 | 44.33 | 23.64 | 114.23 |
| | 5 | hours | 20.68 | 43.71 | 23.03 | 111.40 |
| 100° C. | 10 | minutes | 20.83 | 36.37 | 15.55 | 74.64 |
| | 20 | minutes | 20.69 | 38.61 | 17.92 | 86.60 |
| | 30 | minutes | 20.94 | 39.87 | 18.93 | 90.36 |
| | 40 | minutes | 20.83 | 40.75 | 19.92 | 95.65 |
| | 50 | minutes | 20.96 | 43.50 | 22.54 | 107.57 |

As a result, an increase in absorption amount was reduced under a condition after 1 hour, and at 25° C., the microorganisms could be propagated and it was confirmed by the unaided eye that the dyes were gradually eluted, so that it could not be expected to preserve nutritious ingredients. Even at 50° C. and 100° C., it was confirmed by the unaided eye that the dyes were eluted, so that it could not be expected to preserve nutritious ingredients. From this result, it was confirmed that the black beans immersed at 4° C. for 1 hour became suitable for being applied to the cryogenic micro grinding technology.

### EXAMPLE 2

Preparation and Grinding of Grains

Germinated brown rice, black beans, and a germinated grain and vegetable mixture were purchased from Aunae Nonghyup, cleanly washed with flowing water, and prepared.

In order to confirm effects of grinding conditions on the preservation and absorption rate of nutritious ingredients of the germinated brown rice, two experiments of general grinding and cryogenic micro grinding were carried out.

For the general grinding, cutting, mixing, and grinding were performed for 3 minutes, 3 minutes, and 3 minutes, respectively, by using a home grinder (Shinil Industrial Co. Ltd., SMX-4000DY, Korea). For heat generated during the grinding, the temperature of the powder was measured by using a non-contact type temperature measuring apparatus (Giltron GT300, Taiwan), and the maximum temperature during the grinding was 85° C. Meanwhile, for the cryogenic micro grinding, moisture was sufficiently absorbed by immersing grains in purified water, and then grains absorbing moisture were immersed in liquid nitrogen and frozen at −80° C., and subjected to cryogenic micro grinding while maintaining the temperature at −80° C. by supplying liquid nitrogen. In this case, the particle size of the ground grains and the particle temperature were measured to be 5 μm to 30 μm and −20° C. to −80° C., respectively.

In order to study the particle sizes, particle structures and distributions, and structural analyses of a ground product obtained by general grinding and a ground product obtained by cryogenic micro grinding, a particle size analysis was performed. The particle sizes were measured, and imaging data of particles, such as texture, structure, and shape were measured by a scanning electron microscope. The particle size distribution 10% and 90% values, average particle diameters and median values of powder obtained by general grinding and powder obtained by cryogenic micro grinding were measured.

TABLE 4

| | | Particle size (μm) | | | |
|---|---|---|---|---|---|
| | | Average | Median | | |
| | | value | value | d10 | d90 |
| Germinated | General | 38.38 ± | 45.91 ± | 5.803 ± | 209.11 ± |
| grain and | grinding | 1.27 | 2.14 | 0.27 | 6.09 |
| vegetable | Cryogenic | 5.33 ± | 5.43 ± | 2.16 ± | 12.78 ± |
| mixture | micro grinding | 0.16 | 0.16 | 0.06 | 0.18 |
| Germinated | General | 52.65 ± | 37.88 ± | 4.76 ± | 179.89 ± |
| brown rice | grinding | 1.21 | 0.87 | 0.05 | 6.36 |
| | Cryogenic | 7.22 ± | 6.934 ± | 1.71 ± | 25.75 ± |
| | micro grinding | 0.05 | 0.06 | 0.004 | 0.19 |
| Black bean | General | 29.29 ± | 40.61 ± | 2.760 ± | 174.05 ± |
| (Seoritae) | grinding | 3.58 | 7.76 | 0.28 | 4.46 |
| | Cryogenic | 5.16 ± | 5.21 ± | 2.09 ± | 12.60 ± |
| | micro grinding | 0.09 | 0.1 | 0.04 | 0.03 |

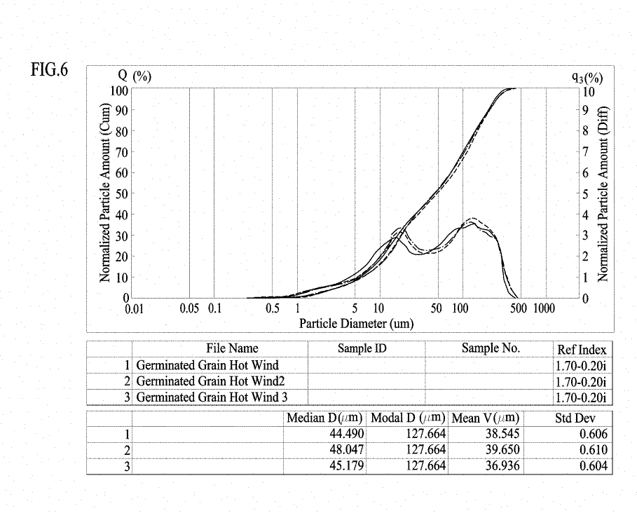

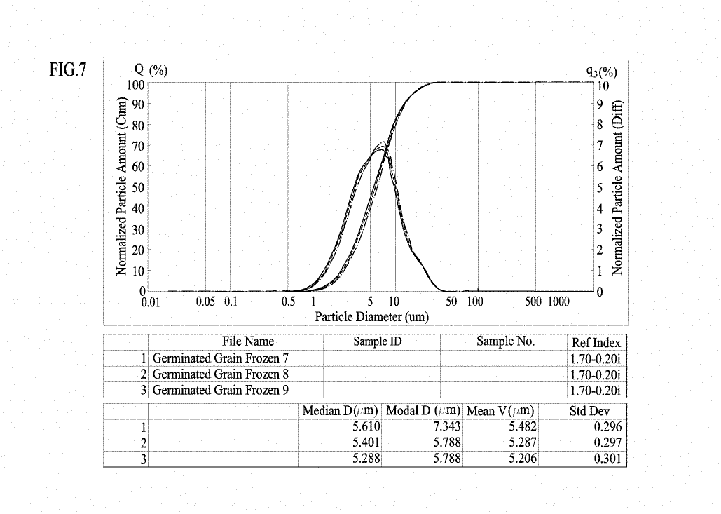

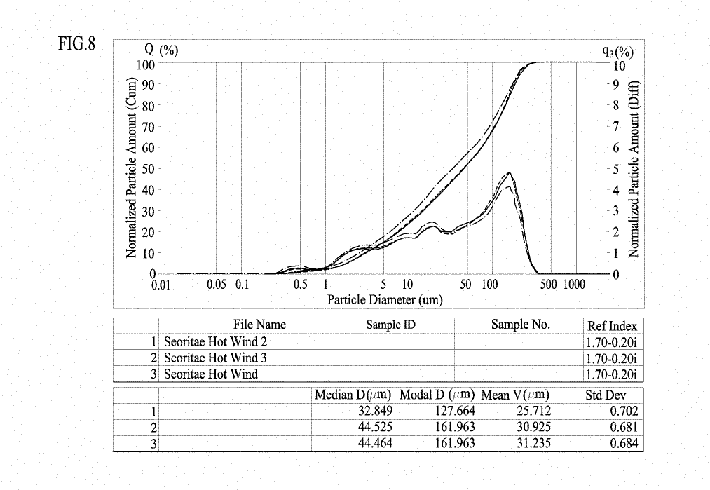

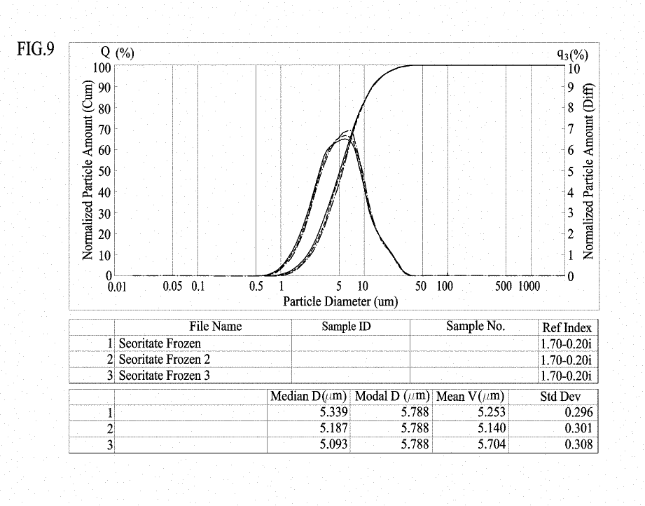

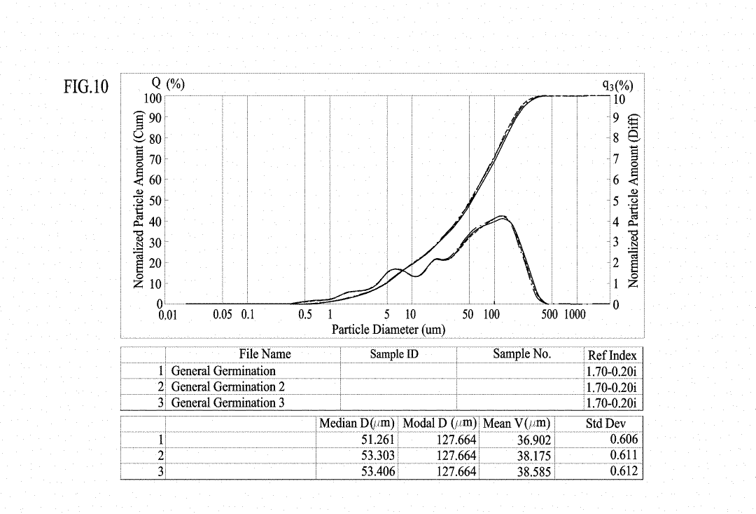

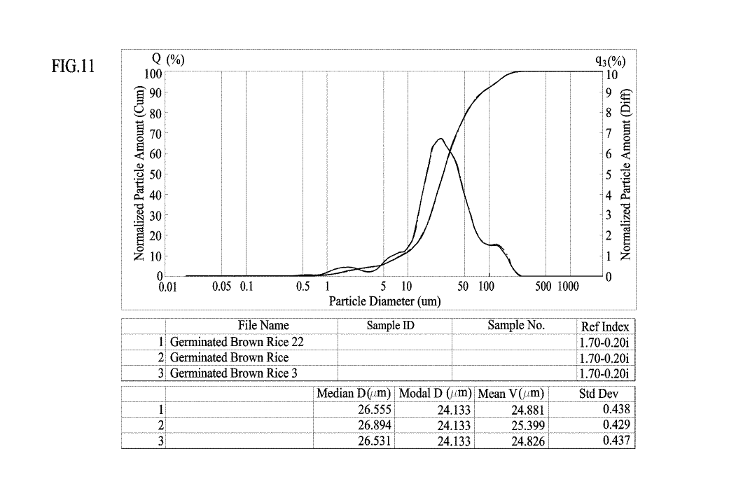

As a result, it was confirmed that for the average particle sizes of samples obtained by subjecting grains to cryogenic micro grinding, the germinated grain and vegetable mixture, the black beans, and the germinated brown rice were 5.33±0.16 μm, 5.16±0.09 μm, and 7.22±0.05 μm, respectively, and the shapes of the particles were generally round or close to a rice grain shape, and the particles were generally evenly distributed (FIGS. 6 to 11).

In contrast, for the average particle sizes of ground products obtained by subjecting grains to general grinding, the germinated grain and vegetable mixture, the germinated brown rice, and the black beans were 38.38±1.27 μm, 52.65±1.21 μm, and 29.29±3.58 μm, respectively, and the shapes of the particles were generally angular or pointed, and the particles were distributed in irregular sizes and shapes.

### EXAMPLE 3

Analysis Results of Nutritious Ingredients of Grains

3-1 Germinated Brown Rice

For the ground products of grains obtained by general grinding and cryogenic micro grinding, Suwon Women's College Food Analysis Research Center (a recognized institution) was requested to measure the content of nutritious ingredients under the generally known methods described in CODEX. In order to compare the contents of nutritious ingredients at 1:1, the content of nutritious ingredients was converted into the content of nutritious ingredients for a moisture content of 0% and expressed.

TABLE 5

| | | General | Cryogenic micro |
|---|---|---|---|
| | Unit | grinding | grinding |
| Calorie | kcal/100 g | 100 | 101.14 |
| Fat | g/100 g | 100 | 107.86 |
| Carbohydrate | g/100 g | 100 | 100.74 |
| Calcium (Ca) | mg/100 g | 100 | 133.78 |
| Iron (Fe) | mg/100 g | 100 | 141.75 |
| Sodium (Na) | mg/100 g | 100 | 251.46 |
| Phosphorus (P) | mg/100 g | 100 | 114.42 |

| | | |
|---|---|---|
| Average | 100% | 134.02% |

As a result, it was confirmed that carbohydrate and fat used as an energy source had a value of 107.86% and 100.74% as compared to general grinding of germinated brown rice, indicating that carbohydrate and fat were better preserved in the cryogenic micro grinding. Inorganic materials such as calcium, iron, sodium, and phosphorus had a value of 133.78%, 141.75%, 251.46%, and 114.42%, respectively, in the cryogenic micro grinding, indicating that these inorganic materials were well preserved. The measured retention rate average of entire nutritious ingredients was 134.02%, which was exhibited to be significantly high, so that it could be confirmed that the cryogenic micro grinding is a grinding method which preserves well nutritious ingredients as compared to a general grinding method.

3-2 Black Bean

Similar to 3-1, a nutrition analysis of black beans (Seoritae) was performed. As a result, it could be seen that on average, the retention rate of a ground product obtained by cryogenic micro grinding to the black bean raw material exhibited a resulting value of 100% or more.

The average difference in retention rate of carbohydrate, fat, and protein used as an energy source was 106.62%, which is significantly high, and the average difference between calcium, iron, potassium, and phosphorus which are minerals and vitamin b2 also exhibited 106.22%, which is an excellent resulting value. In particular, the retention rate of β-carotene which is a precursor material of vitamin A which is a functional ingredient of black beans was 228.9%, showing a characteristic in that the precursor material is well preserved.

The ground product obtained by cryogenic micro grinding has a nutritious ingredient retention rate of more than 100% as compared to that of the raw material because the higher the grindability is, the larger the surface area is, and as a result, nutritious ingredients are more likely to be eluted. Furthermore, the size of a cell is approximately 150 μm, a d10 value of 3.75±0.51 from the black beans by cryogenic micro grinding means that the amount of a powder having a diameter less than the size is 10%, and a d90 value of 83.53±7.36 from the black beans by cryogenic micro grinding means that the amount of a powder having the size is 90%, so that it can be seen that for powder with d10 to d90, one cell is degraded into 1/40 to 1/1.79 fragments. Accordingly, most of the black beans are ground to less than the cell size by cryogenic micro grinding, so that it can be seen that the elution rate of nutritious ingredients present in the cell wall or cytoplasm increases.

TABLE 6

| | | Raw | Cryogenic micro |
|---|---|---|---|
| Nutritious Ingredient | Unit | material | grinding |
| Calorie | Kcal/100 g | 100 | 104.65 |
| Fat | g/100 g | 100 | 129.11 |
| Protein | g/100 g | 100 | 102.53 |
| Ash | g/100 g | 100 | 101.47 |
| Carbohydrate | g/100 g | 100 | 88.21 |
| β-carotene | μg/100 g | 100 | 228.90 |
| Calcium | mg/100 g | 100 | 95.25 |
| Iron | mg/100 g | 100 | 96.00 |
| Potassium | mg/100 g | 100 | 99.54 |
| Phosphorus | mg/100 g | 100 | 106.97 |
| Vitamin B2 | mg/100 g | 100 | 133.33 |
| Dietary fiber | g/100 g | 100 | 102.38 |
| Average retention rate (%) | | | 115.67 |

### EXAMPLE 4

Comparison of In Vivo Digestion Rate According to General Grinding and Cryogenic Micro Grinding

In order to investigate effects of general grinding and cryogenic micro grinding on the digestion speed of carbohydrate which is an energy source, the content of glucose produced by treating the carbohydrate with α-amylase was stained and the absorbance was measured to confirm effects of general grinding and cryogenic micro grinding on the digestion speed in the mouth.

Experimental Method of α-Amylase

5.0 g of amylase was precisely weighed, dissolved in water or a Mcilvaine's buffer solution to prepare a 100 mL of a solution, and then the resulting solution was filtered and used as an enzyme solution. Two 20-mL test tubes were prepared and used as a test tube for test and as a test tube for blank, respectively. 0.05 g of a sample was precisely weighed and put into a test tube for test, 0.45 mL of water was added thereto, 13 mL of the Mcilvaine's buffer solution (pH 7.0) and 1 mL of a 0.1% calcium chloride solution were added thereto, the resulting mixture was warmed to 37° C., 1 mL of the enzyme solution was added thereto, and then the resulting mixture was subjected to enzyme solution in a water bath at 37° C. for 20 minutes. The enzyme activity was deactivated by heating the test tube at 100° C. for 10 minutes, the test tube was cooled at room temperature, and then centrifuged at 4° C. and 10,000 rpm for 10 minutes to use the supernatant as a reaction solution. Apart from this, 0.05 g of a sample was precisely weighed and put into a test tube for blank, 0.45 mL of water was added thereto, 13 mL of the Mcilvaine's buffer solution (pH 7.0) and 1 mL of a 0.1% calcium chloride solution were added thereto, the test tube was heated at 100° C. for 10 minutes, cooled at room temperature, and then centrifuged at 4° C. and 10,000 rpm for 10 minutes to use the supernatant as a reaction solution for blank. Solutions obtained by adding 1.2 mL of a DNS solution to 0.4 mL of each of a reaction solution for test and a reaction solution for blank were used as test solutions. The absorbance was measured at a liquid layer of 1 cm and a wavelength of 540 nm by using water as a control solution. In this case, the absorbance of the test solution needs to be higher than that of the solution for blank. When the degree of staining was so high that it was difficult to measure the absorbance, the reaction solution was diluted and tested, and the dilution multiple was applied. When the intensity of light after transmission is divided by the intensity of light before transmission, the transmittance was calculated, and the absorbance was calculated from absorbance=1−transmittance. Accordingly, an absorbance of 0 means complete transmission, and an absorbance of 1 means complete absorption.

In order to measure the content of glucose, the glucose solution (the most pure product) was diluted with a standard material to set the concentration to 10 μg/mL to 1,000 μg/mL, and a calibration line was drawn up by performing an experiment according to the experimental method of amylase using the resulting solution as a sample. For the calculation of glucose content, the amount of glucose in the sample was inversely calculated by using a calibration line. The digestion rate was calculated by the following equation.

Digestion rate=Content of glucose after α-amylase reaction/Content of glucose of sample for blank×100

TABLE 7

| | | | Comparison of |
|---|---|---|---|
| | General | Cryogenic micro | digestion |
| | grinding | grinding | efficiencies |
| Item | (A) | (B) | (%, B/A × 100) |
| Black bean (Seoritae) | 0.24 | 0.37 | 154.17 |
| Germinated brown rice | 0.06 | 2.58 | 4300.00 |
| Germinated grain and | 0.02 | 0.03 | 150.00 |
| vegetable mixture | | | |

As a result, the contents of glucose produced by treating powder obtained by cryogenic micro grinding with α-amylase were exhibited to be higher in the black beans, the germinated brown rice, and the germinated grain and vegetable mixture powder by 54.17%, 4,200%, and 50%, respectively, than those obtained by general grinding. From this result, it could be seen that the cryogenic micro grinding is a technology which allows the digestion process in the mouth to proceed well. The experiment coincides with a study result that heat generated during the grinding process causes a Maillard reaction in which sugars bind to proteins in food, and thus, decreases a substrate upon which α-amylase can act. In particular, the germinated brown rice has a structure which is not relatively hard as compared to those of the black bean and the germinated grain and vegetable mixture, so that during the process in which the germinated brown rice is swollen by immersion and then subjected to cryogenic micro grinding, the germinated brown rice is more likely to be brought into contact with α-amylase, and as a result, the amount of glucose produced is also significantly increased.

It is to be understood that the above-described products and methods are merely illustrative embodiments of the principles of this disclosure, and that other composition and methods may be devised by one of ordinary skill in the art, without departing from the spirit of the present invention. It is also to be understood that the disclosure is directed to embodiments both comprising and consisting of the disclosed parts.

What is claimed is:

1. Method of producing a grain powder comprising:
(a) immersing a grain raw material into water;
(b) freezing the immersed grain raw material at −196° C. to −50° C.;
(c) grinding the frozen grain raw material to obtain a ground product, wherein the ground product has an average particle size smaller than a cell size of the grain raw material, and
(d) freeze-drying the ground product at −80° C. to −20° C. to obtain the grain powder.

2. The method of claim 1, wherein the grinding step (c) is performed at −80° C. to −50° C.

3. The method of claim 1, wherein the grain raw material is selected from the group consisting of germinated brown rice, black bean, and a germinated grain and vegetable mixture.

4. The method of claim 1, wherein the average particle size of the ground product is 5 to 30 μm.

5. The method of claim 1, wherein the immersing step (a) is performed at 2° C. to 20° C. for 60 to 180 minutes.

6. The method of claim 1, wherein the grain powder has a higher nutrient retention rate than the grain raw material.

7. The method of claim 1, wherein the grain powder has a higher in vivo digestion rate than the grain raw material.

8. The method of claim 3, wherein the grain raw material is black bean or a germinated grain and vegetable mixture, and
wherein an in vivo digestion rate of the grain powder is 50 to 60% higher than an in vivo digestion rate of the grain raw material.

9. The method of claim 3, wherein the grain raw material is germinated brown rice, and
wherein an in vivo digestion rate of the grain powder is 3,500 to 4,500% higher than an in vivo digestion rate of the grain raw material.

10. The method of claim 1, wherein the freezing step (b) is performed by using a liquid nitrogen.

11. The method of claim 1, wherein the temperature of the ground product is maintained between −80° C. to −20° C. during the grinding step (c).

12. A grain powder comprising:
a freeze-dried and ground grain raw material,
wherein an average particle size of the grain powder is smaller than a cell size of the grain raw material, and
wherein the grain powder has a higher nutrient retention rate than the grain raw material, and the grain powder has a higher in vivo digestion rate than the grain raw material.

13. A food product comprising the grain powder of claim 12.

14. The food product of claim 13, further comprising: one or more of a carrier, a diluent, an excipient, and an additive.

15. The food product of claim 13, wherein the food product is in a form of a powder, a granule, a tablet, a capsule, a syrup or a bar.
